(19) United States
(12) Patent Application Publication
(10) Pub. No.: US 2026/0093120 A1
(43) Pub. Date: Apr. 2, 2026

(54) VIRTUAL IMAGE DISPLAY APPARATUS AND OPTICAL UNIT

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 19/344,345

(22) Filed: Sep. 29, 2025

(30) Foreign Application Priority Data
Sep. 30, 2024 (JP) 2024-170148

(51) Int. Cl. G02B 27/01

(52) U.S. Cl. CPC G02B 27/0172; G02B 2027/0178

(57) ABSTRACT

A virtual image display apparatus includes a display element, a first prism, a second prism bonded to the first prism, a reflective polarizing element which is disposed at a junction portion between the first prism and the second prism via an adhesive member, and is configured to reflect at least a part of an image light guided in the first prism, a lens having positive power and disposed so as to face an outer side surface of the first prism, a transmissive mirror formed at an external side of the lens, and configured to partially reflect the image light toward the reflective polarizing element, and a quarter-wave plate disposed between the outer side surface of the first prism and the lens. The reflective polarizing element has a light deflector in an end area close to an inner side surface at an opposite side to the outer side surface.

The present application is based on, and claims priority from JP Application Serial Number 2024-170148, filed September 30, 2024, the disclosure of which is hereby incorporated by reference herein in its entirety.

### BACKGROUND

### Technical Field

The present disclosure relates to a direct virtual image-type virtual image display apparatus and an optical unit that enable observation of a virtual image.

### Related Art

As a head-mounted display apparatus, there is known to the public a head-mounted display apparatus including a liquid crystal image display panel, a first lens, a beam splitter, a concave mirror, a quarter-wave plate, and a second lens, in which image light from the liquid crystal image display panel is incident on the beam splitter to be reflected by a beam splitting surface that reflects polarized light in a first polarization direction, then travels back and forth through the quarter-wave plate when being reflected by the concave mirror, and is transmitted through the beam splitter as polarized light in a second polarization direction (see JP-T-2003-502710).

JP-T-2003-502710 is an example of the related art.

The head-mounted display apparatus described above has a configuration in which an intermediate image is not generated, and an optical diaphragm is not provided. Therefore, unnecessary light is confined in a light guide plate, which causes a problem that the unnecessary light reaches the eyes.

### SUMMARY

A virtual image display apparatus in one aspect of the present disclosure includes a display element configured to emit image light, a first prism on which the image light from the display element is incident, a second prism bonded to the first prism to constitute a prism-based light guide member having a parallel flat plate shape, a reflective polarizing element which is disposed at a junction portion between the first prism and the second prism via an adhesive member, and is configured to reflect at least a part of the image light guided in the first prism, a lens having positive power and disposed so as to face an outer side surface of the first prism on which the image light reflected by the reflective polarizing element is incident, a transmissive mirror formed at an external side of the lens, and configured to partially reflect, toward the reflective polarizing element, the image light reflected by the reflective polarizing element, and a quarter-wave plate disposed between the outer side surface of the first prism and the lens, in which the reflective polarizing element has a light deflector in an end area close to an inner side surface at an opposite side to the outer side surface.

An optical unit in one aspect of the present disclosure includes a first prism on which the image light from the display element is incident, a second prism bonded to the first prism to constitute a prism-based light guide member having a parallel flat plate shape, a reflective polarizing element which is disposed at a junction portion between the first prism and the second prism via an adhesive member, and is configured to reflect at least a part of the image light guided in the first prism, a lens having positive power and disposed so as to face a first outer side surface of the first prism on which the image light reflected by the reflective polarizing element is incident, a transmissive mirror formed at an external side of the lens, and configured to partially reflect, toward the reflective polarizing element, the image light reflected by the reflective polarizing element, and a quarter-wave plate disposed between the outer side surface of the first prism and the lens, in which the reflective polarizing element has a light deflector in an end area close to an inner side surface at an opposite side to the outer side surface.

### BRIEF DESCRIPTION OF THE DRAWINGS

FIG. 1 is an appearance diagram illustrating a use situation of a virtual image display apparatus according to a first embodiment.

FIG. 2 is a side cross-sectional view illustrating an internal structure of the virtual image display apparatus at one side.

FIG. 3 is a perspective view of the virtual image display apparatus.

FIG. 4 is an exploded view of a first flat-plate member.

FIG. 5 is a view of a second prism and a reflective polarizing element viewed from the external side.

FIG. 6 is a side cross-sectional view of a prism-based light guide member.

FIG. 7 is an enlarged cross-sectional view illustrating the reflective polarizing element before being attached to a prism.

FIG. 8 is a diagram illustrating optical paths and so on of the virtual image display apparatus shown in FIG. 2 and so on.

FIG. 9 is a conceptual diagram specifically illustrating unnecessary light incident on an upper portion of a first prism.

FIG. 10 is a conceptual diagram specifically illustrating an optical path of the unnecessary light incident on a first prism.

FIG. 11 is a conceptual diagram specifically illustrating another optical path of the unnecessary light incident on the first prism.

FIG. 12 is a diagram illustrating a projection state of unnecessary light in the virtual image display apparatus of a practical example.

FIG. 13 is a diagram illustrating a projection state of unnecessary light in a virtual image display apparatus of a comparative example.

FIG. 14 is a diagram illustrating a reflective polarizing element of a virtual image display apparatus according to a second embodiment.

FIG. 15 is a diagram illustrating a projection state of unnecessary light in the virtual image display apparatus shown in FIG. 14.

FIG. 16 is a side cross-sectional view illustrating a virtual image display apparatus according to a third embodiment.

FIG. 17 is a side cross-sectional view illustrating a virtual image display apparatus according to a modified example.

### DESCRIPTION OF EMBODIMENTS

### First Embodiment

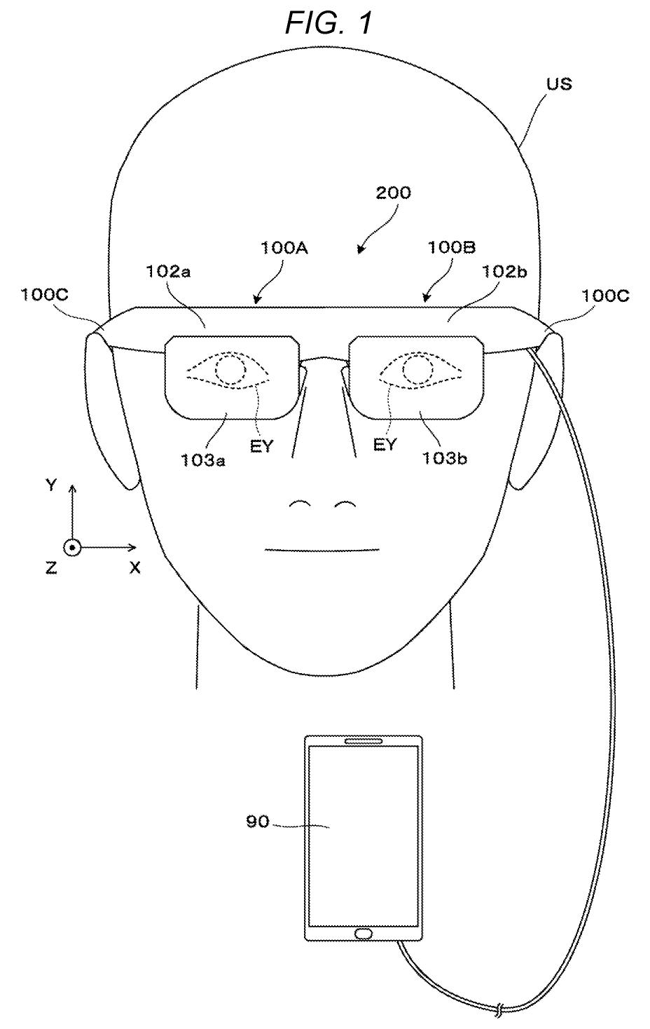

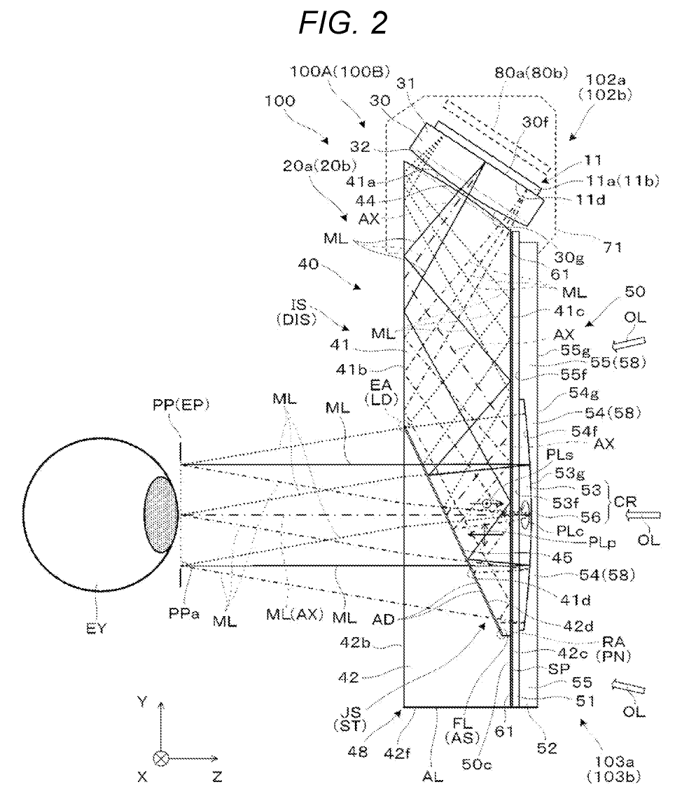

A first embodiment of a virtual image display apparatus and so on according to the present disclosure will hereinafter be described with reference to FIGS. 1, 2, and so on.

FIG. 1 is a diagram illustrating a state in which a head-mounted virtual image display apparatus (hereinafter also referred to as head-mounted display or HMD) 200 is mounted. The HMD 200 causes an observer or wearer US who wears the HMD 200 to recognize an image as a virtual image. In FIG. 1 and so on, the axes X, Y, and Z represent an orthogonal coordinate system. A +X direction corresponds to a lateral direction in which the two eyes EY of the observer or wearer US, who wears the HMD 200, are arranged. A +Y direction corresponds to an upward direction orthogonal to the lateral direction in which the two eyes EY are arranged for the wearer US. A +Z direction corresponds to a forward direction or a frontward direction for the wearer US. The ±Y directions are made parallel to a vertical axis or a vertical direction.

The HMD 200 includes a direct virtual image-type first virtual image display apparatus 100A for a right eye, a direct virtual image-type second virtual image display apparatus 100B for a left eye, a pair of temple-shaped support devices 100C for supporting the virtual image display apparatus 100A, 100B, and a user terminal 90 as an information terminal. The first virtual image display apparatus 100A independently functions as an HMD, and includes a first display driver 102a disposed at an upper portion of the first virtual image display apparatus 100A and a first combiner 103a which is shaped like a spectacle lens and covers the front side of the eye. Similarly, the second virtual image display apparatus 100B independently functions as an HMD and includes a second display driver 102b disposed at an upper portion of the second virtual image display apparatus 100B and a second combiner 103b which is shaped like a spectacle lens and covers the front side of the eye. The pair of support devices 100C are a mounting member mounted on the head of the wearer US. The pair of support devices 100C support upper ends of the pair of combiners 103a, 103b via the display drivers 102a, 102b integrated with each other in appearance. The first virtual image display apparatus 100A and the second virtual image display apparatus 100B are optically the same or horizontally flipped.

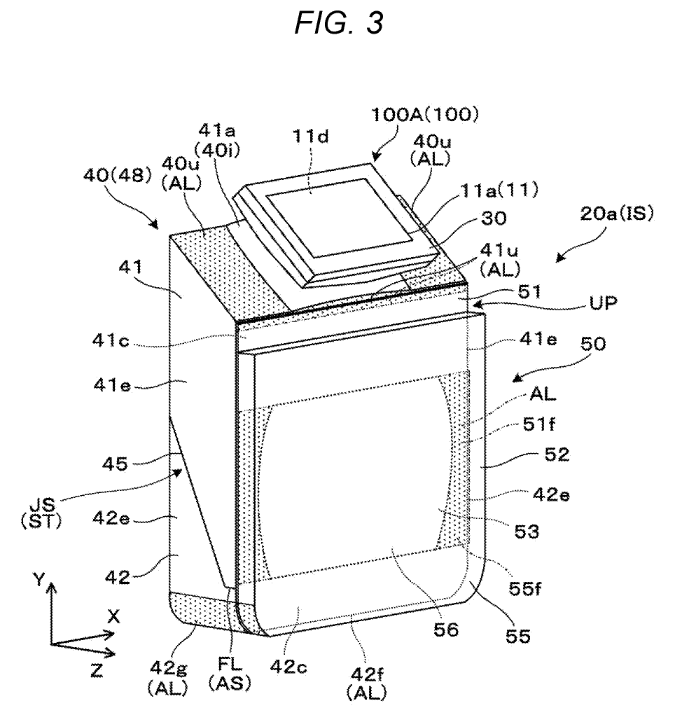

FIG. 2 is a side cross-sectional view illustrating an internal structure of the first virtual image display apparatus 100A. FIG. 3 is a perspective view of the first virtual image display apparatus 100A. The first virtual image display apparatus 100A includes a first image forming element 11a, a first display unit 20a, and a first circuit member 80a. The first image forming element 11a is also referred to as a display element 11. The first display unit 20a is an imaging optical system IS, which directly forms a virtual image without forming an intermediate image. The first display unit 20a is also referred to as a direct virtual image optical system DIS. The imaging optical system IS includes a first lens 30, a first flat-plate member 40, and a second flat-plate member 50. The first lens 30 has a function as a protective glass that protects a display surface 11d of the display element 11. Note that a cover glass may be disposed between the display element 11 and the first lens 30. The first flat-plate member 40 guides image light ML output from the display element 11 to a second lens 53 of the second flat-plate member 50. The second flat-plate member 50 reflects the image light ML from the first flat-plate member 40 toward a pupil position PP or the eye EY so as to partially direct the image light ML back to the first flat-plate member 40, and causes external light OL to be incident on the pupil position PP via the first flat-plate member 40. The first lens 30, the first flat-plate member 40, and the second flat-plate member 50 each have a function as a lens having positive refractive power.

Although not described in detail, the second virtual image display apparatus 100B includes a second image forming element 11b, a second display unit 20b, and a second circuit member 80b. The second image forming element 11b is substantially the same as the first image forming element 11a. The second display unit 20b is substantially the same as the first display unit 20a. The second circuit member 80b is substantially the same as the first circuit member 80a.

In the first virtual image display apparatus 100A, the first image forming element 11a is a self-luminous image light generator. The first image forming element 11a outputs the image light ML to the first flat-plate member 40 via the first lens 30. The first image forming element 11a is housed in and supported by an enclosure 71. The first image forming element 11a is, for example, an organic electro-luminescence (EL) display. The first image forming element 11a forms a color still image or a color moving image on the display surface 11d as a two-dimensional surface. The first image forming element 11a is driven by the first circuit member 80a to perform a display operation. The first image forming element 11a is not limited to an organic EL display, and can be replaced with a display device using inorganic EL, an organic LED, an LED array, a laser array, a quantum dot luminous element, or the like. The first image forming element 11a is not limited to a self-luminous image light generator, and may be a device which is configured with a light modulation element such as an LCD and forms an image by illuminating the light modulation element with a light source such as a backlight. As the first image forming element 11a, a liquid crystal on silicon (LCOS, LCoS is a registered trademark) or the like can be used in place of the LCD. Note that an optical apparatus obtained by excluding the first circuit member 80a from the first virtual image display apparatus 100A is referred to as an optical unit 100. It can be said that the optical unit 100 is a portion which includes a direct virtual image-type optical system and corresponds to a direct virtual image optical system DIS constituting the first virtual image display apparatus 100A.

The first display unit 20a includes the first lens 30, the first flat-plate member 40, a reflective polarizing element 45, and the second flat-plate member 50. In the first display unit 20a, the first lens 30 has positive refractive power, and the image light ML from the first image forming element 11a enters the first lens 30. The first lens 30 has a plane of incidence of light 30f as a flat surface to be bonded to the first image forming element 11a, and a light exit surface 30g as a convex surface. The light exit surface 30g is, for example, a spherical surface, and may be an aspherical surface having an axisymmetric shape. The first lens 30 can be conceptually divided into a parallel flat plate 31 and a lens portion 32. Foreign matter having adhered to the surface of the first lens 30 becomes inconspicuous by ensuring the thickness of the parallel flat plate 31 no smaller than a predetermined value. The parallel flat plate 31 has a function as a cover glass. The lens portion 32 is a planoconvex lens having positive refractive power. One surface of the planoconvex lens has a planar shape, and the other surface thereof has a convex shape. Note that the parallel flat plate 31 and the lens portion 32 may be bonded to each other or may be separated from each other. The lens portion 32 is not required to be a planoconvex lens, and may be, for example, a biconvex lens. Further, the first lens 30 is made of, for example, fused quartz and has a relatively low refractive index.

The first flat-plate member 40 includes a first prism 41 shaped like a parallel flat plate and a second prism 42 shaped like a parallel flat plate. The first prism 41 and the second prism 42 are bonded to each other at the inclined surfaces 41d, 42d with the reflective polarizing element 45 interposed therebetween. What is obtained by bonding the first prism 41 and the second prism 42 to each other is referred to as a prism-based light guide member 48. The prism-based light guide member 48 has an appearance of a parallel flat plate. What is obtained by combining the prism-based light guide member 48 and the second flat-plate member 50 described later corresponds to the first combiner 103a.

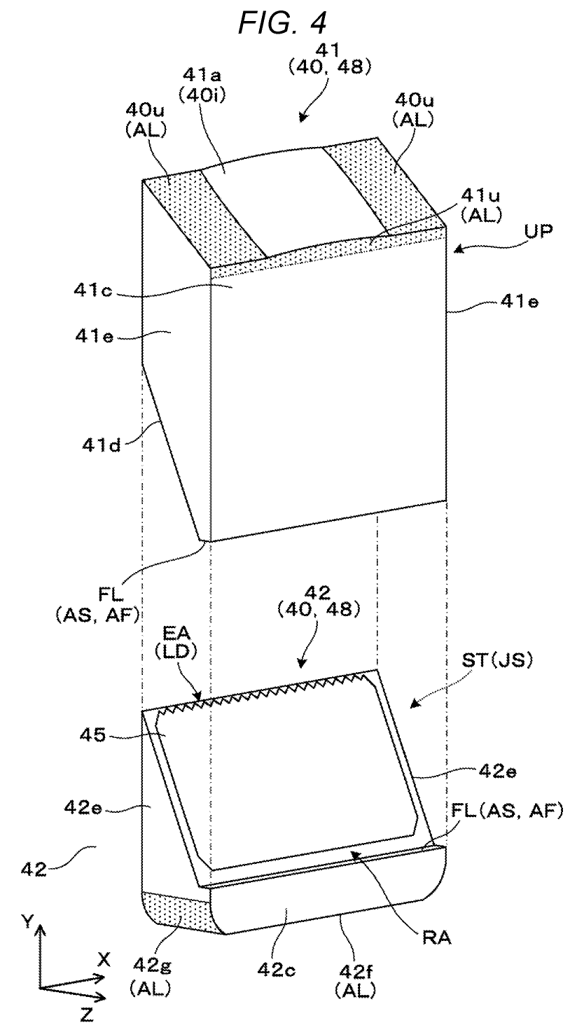

FIG. 4 is an exploded view of the first flat-plate member 40. As shown in FIGS. 2 to 4, the first prism 41 has a quadrangular prismatic outer shape and has a trapezoidal longitudinal cross-section. The first prism 41 is for guiding the image light ML. The first prism 41 has an optical plane of incidence 41a, a first inner side surface 41b, a first outer side surface 41c, and the first inclined surface 41d. Further, the first prism 41 further has an upper flat surface 40u and first lateral side surfaces 41e. Here, the optical plane of incidence 41a inclines downward on the front side thereof as a whole, and an optical axis passing through the optical plane of incidence 41a extends in a direction between the +Z direction as a frontward direction, and the +Y direction as an upward direction. Thus, it becomes easy to dispose the first image forming element 11a as the display element 11 at an external side of the first inner side surface 41b, and thus, it is possible to adjust an angle at which the image light ML is made to propagate in the first prism 41 (in the first prism 41 or through the inside of the first prism 41). The optical plane of incidence 41a is a convex surface such as a spherical surface, and may instead be an axisymmetric aspherical surface. It is conceivable that the first prism 41 is provided with a lens portion 44 having the optical plane of incidence 41a. The lens portion 44 is a planoconvex lens having positive refractive power. The lens portion 44 may be directly formed as a part of the first prism 41 or may be bonded to the first prism 41. The first inner side surface 41b and the first outer side surface 41c are parallel to each other and extend in a direction perpendicular to an optical axis AX between the pupil position PP, and the first inner side surface 41b and the first outer side surface 41c. The first inner side surface 41b and the first outer side surface 41c are for internally reflecting the image light ML (i.e., reflecting the image light ML at inner side of an object surface), and are particularly preferable for totally reflecting the image light ML. The scratch resistance or scuff resistance of the first inner side surface 41b can be enhanced by being provided with a hard coat. The first lateral side surfaces 41e are disposed between the first outer side surface 41c and the first inner side surface 41b so as to face each other in a lateral direction, that is, the X direction crossing the Y direction in which the first prism 41 and the second prism 42 are arranged. The first inclined surface 41d is a flat surface. The first inclined surface 41d is at an acute angle with the first outer side surface 41c, specifically an angle in a range from 25° to 32°. Note that a distance between the optical axis AX passing through the pupil position PP and an upper end of the first lens 30 is about 20 mm. The first prism 41 is made of a resin material.

The number of times of reflection of the image light ML in the first prism 41 is one at the first inner side surface 41b, one at the first outer side surface 41c, and further, one at the reflective polarizing element 45 described later. By setting the number of times of internal reflection of the image light ML in the first prism 41 to two, it is possible to efficiently avoid mixture of light different in number of times of reflection in the first prism 41 while increasing a field angle of the image light ML, and the pupil position PP or an aperture PPa at the pupil position PP. In addition, it becomes easy to shorten the distance from the display element 11 to a transmissive mirror 56 of a cover member 52 described later, and thus, the prism-based light guide member 48 can be reduced in size, and it is also easy to reduce the sizes of the display element 11 and the first lens 30.

Similarly to the first prism 41, the second prism 42 has a quadrangular prismatic outer shape and has a trapezoidal longitudinal cross-section. The second prism 42 is for transmitting the image light ML. The second prism 42 has a second inner side surface 42b, a second outer side surface 42c, a second inclined surface 42d, and a bottom surface 42f. The bottom surface 42f is a surface opposed to the optical plane of incidence 41a at an opposite side in the prism-based light guide member 48 or the first flat-plate member 40. Further, the bottom surface 42f is a surface opposed to the second inclined surface 42d at an opposite side in the second prism 42. Further, the second prism 42 has second lateral side surfaces 42e. Here, the second inner side surface 42b and the second outer side surface 42c are parallel to each other, and extend in a direction perpendicular to the optical axis AX between the pupil position PP and the second inner side surface 42b and the second outer side surface 42c. The scratch resistance of the second inner side surface 42b can be enhanced by being provided with a hard coat. The second lateral side surfaces 42e are disposed between the second outer side surface 42c and the second inner side surface 42b so as to face each other in a lateral direction, that is, the X direction crossing the Y direction in which the first prism 41 and the second prism 42 are arranged. The second prism 42 is made of a resin material.

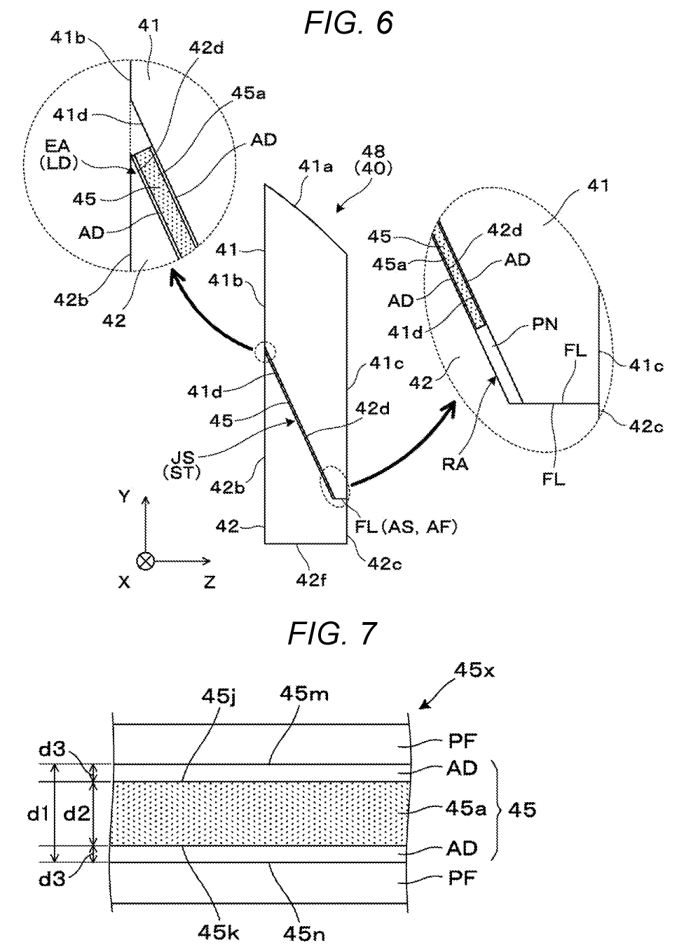

An inclined surface portion ST which is a junction portion JS between the first prism 41 and the second prism 42 has planar portions FL at a side closer to the first and second outer side surfaces 41c, 42c. Both the planar portions FL are formed continuously from lower ends of the first inclined surface 41d and the second inclined surface 42d. Both the planar portions FL are at obtuse angles with the first inclined surface 41d and the second inclined surface 42d, and extend in substantially parallel to the X-Z plane. The planar portions FL are positioning structures AS disposed on the peripheries of the inclined surfaces 41d, 42d of the first prism 41 and the second prism 42. When the first prism 41 and the second prism 42 are bonded to each other, the pair of planar portions FL disposed adjacent to the inclined surfaces 41d, 42d are also brought into contact with each other as contact surfaces AF extending in parallel to each other by causing the inclined surfaces 41d, 42d to face each other and approach each other. Accordingly, the first prism 41 and the second prism 42 can be positioned in an inclination direction of the inclined surfaces 41d, 42d, that is, in the intermediate direction between the Z direction and the Y direction, and can be positioned around an axis perpendicular to the inclined surfaces 41d, 42d. As a result, the planar portions FL position the first prism 41 and the second prism 42 in the +Z direction or the depth direction, and set the mutual rotational posture as designed. By using the planar portions FL as the contact surfaces AF, it is possible not only to facilitate assembly of joining the first prism 41 and the second prism 42 to each other, but also to cause the planar portions FL to function as displacement prevention portions. Accordingly, it is possible to increase a bonding accuracy between the first prism 41 and the second prism 42. A gap PN is formed between the first prism 41 and the second prism 42 in an area where the reflective polarizing element 45 is not disposed (see FIG. 2, and FIG. 6 described later). A distance from a lower end of the reflective polarizing element 45 to the outer side surfaces 41c, 42c is increased with relative ease, and it is easy to dispose the planar portions FL, that is, the positioning structures AS. Note that, as long as a non-reflective area can be sufficiently ensured, the junction portion JS between the first prism 41 and the second prism 42 may have planar portions as the positioning structures AS at a side closer to the first and second inner side surfaces 41b, 42b.

The reflective polarizing element 45 reflects at least a part of the image light ML guided in the first prism 41. The reflective polarizing element 45 is disposed at the junction portion JS between the first prism 41 and the second prism 42 via an adhesive member AD. That is, the reflective polarizing element 45 is attached to the first inclined surface 41d of the first prism 41 and the second inclined surface 42d of the second prism 42 with the adhesive member AD. The reflective polarizing element 45 is formed in areas except the outer edge portions of the inclined surfaces 41d, 42d of the first prism 41 and the second prism 42 which are therefore one-size smaller than the inclined surfaces 41d, 42d.

The reflective polarizing element 45 is, for example, a polarization beam splitter having a characteristic of reflecting s-polarized light. The reflective polarizing element 45 efficiently reflects the image light ML as s-polarized light PLs when the image light ML contains the s-polarized light PLs, and efficiently transmits the image light ML as p-polarized light PLp when the image light ML contains the p-polarized light PLp. The reflective polarizing element 45 is only required to selectively reflect the image light ML in accordance with the polarization direction of the image light ML. Note that the reflective polarizing element 45 may be what transmits the s-polarized light PLs and reflects the p-polarized light PLp.

Examples of the reflective polarizing element 45 include a multilayer film, a wire grid polarizer such as a wire grid film, and a reflective polarizing element using film stretching.

The reflective polarizing element 45 is only required to have a surface that is flat enough not to affect the image formation. Further, the reflective polarizing element 45 may have a minute convexly or concavely curved surface to the extent that the image formation is not affected. The scratch resistance or scuff resistance of the reflective polarizing element 45 can be enhanced by providing the surface thereof with a hard coat.

Details of the structure and so on of the reflective polarizing element 45 will be described later.

As shown in FIG. 2 and so on, the second flat-plate member 50 includes a quarter-wave plate 51 shaped like a thin plate, and a cover member 52. The quarter-wave plate 51 is formed of a crystal, a liquid crystal material, or the like having an optical axis between the X direction and the Y direction. The quarter-wave plate 51 converts the image light ML as the s-polarized light PLs reflected by the reflective polarizing element 45 into circularly polarized light PLc, and converts the image light ML as the circularly polarized light PLc reflected by the cover member 52 into the p-polarized light PLp. The cover member 52 includes the second lens 53 as a planoconvex lens, a compensation lens 54 as a planoconcave lens, a compensation flat plate 55 disposed on the periphery of the compensation lens 54 and extending in parallel to the prism-based light guide member 48, and a transmissive mirror 56.

The second flat-plate member 50 is disposed at a distance in a range from about 20 μm to 100 μm from the first flat-plate member 40. There is a possibility that the first outer side surface 41c and the second outer side surface 42c of the first flat-plate member 40 and a third inner side surface 50c of the second flat-plate member 50 is slightly curved, so that a minute step is formed on the boundary between the first outer side surface 41c and the second outer side surface 42c, but it is possible to prevent these surfaces from coming excessively close to each other by setting the distance between the first and second outer side surfaces 41c, 42c and the third inner side surface 50c to no less than 20 μm, more preferably, no less than 30 μm. Conversely, by setting the distance between the first and second outer side surfaces 41c, 42c and the third inner side surface 50c to no more than 100 μm, it is possible to prevent the thickness of the first combiner 103a having the first flat-plate member 40 and the second flat-plate member 50 combined with each other from increasing. A spacer 61 for adjusting the distance between the first flat-plate member 40 and the second flat-plate member 50 and fixing the first flat-plate member 40 and the second flat-plate member 50 in a state in which the first flat-plate member 40 and the second flat-plate member 50 are positioned with each other is disposed between the first and second outer side surfaces 41c, 42c of the first flat-plate member 40 and the third inner side surface 50c of the second flat-plate member 50. The spacer 61 is not provided over the entire circumference of the second flat-plate member 50. That is, a gap SP between the first flat-plate member 40 and the second flat-plate member 50 is not sealed but communicates with the outside.

In the cover member 52, the second lens 53 is disposed so as to face the first outer side surface 41c of the first prism 41 or the quarter-wave plate 51. The second lens 53 collects the image light ML. The second lens 53 is a planoconvex lens that is thin but has positive refractive power. One surface of the planoconvex lens has a planar shape, and the other surface thereof has a shape convex outward. The second lens 53 has a flat surface 53f bonded to the quarter-wave plate 51 and a convex surface 53g facing the compensation lens 54. The convex surface 53g is, for example, a spherical surface, and may be an axisymmetric aspherical surface. The compensation lens 54 is thin but has positive refractive power. The compensation lens 54 has a concave surface 54f facing the second lens 53, and a flat surface 54g. The compensation flat plate 55 is a parallel flat plate. The compensation flat plate 55 has a pair of flat surfaces 55f, 55g. Here, a shape facing the concave surface 54f of the compensation lens 54 is the same as the shape of the convex surface 53g of the second lens 53. The flat surface 54g of the compensation lens 54 and the flat surface 55g of the compensation flat plate 55 are coplanar with each other and are continuous with each other. The transmissive mirror 56 is a thin film formed on the convex surface 53g of the second lens 53 at an external side thereof, and has the same shape as the shape of the convex surface 53g. A combination of the second lens 53 and the transmissive mirror 56 is referred to as a light collecting reflector CR.

The second lens 53, the compensation lens 54, and the compensation flat plate 55 are made of a resin material and have the same refractive index. The refractive index of the second lens 53 and so on is lower than the refractive index of the first prism 41. The compensation lens 54 and the compensation flat plate 55 are integrally formed of the same resin material into an optical element 58.

A combination of the second lens 53, the compensation lens 54, and the compensation flat plate 55 functions as a parallel flat plate as a whole. That is, the external light OL incident on the surfaces of the compensation lens 54 and the compensation flat plate 55 passes through the compensation lens 54 and the compensation flat plate 55 without being affected by the lens effects provided by the compensation lens 54 and so on and the step located at an outer edge of the compensation lens 54. In this way, the compensation lens 54 optically compensates for the influence of the second lens 53 on the external light OL. In this sense, the flat surface 53f of the second lens 53, the flat surface 54g of the compensation lens 54, and the flat surfaces 55f, 55g of the compensation flat plate 55 are each not necessarily limited to a flat surface in an exact sense, and may each be, for example, a substantially flat surface or may each partially or entirely include a curved surface. In addition, the flat surface 53f of the second lens 53, the flat surface 54g of the compensation lens 54, and the flat surfaces 55f, 55g of the compensation flat plate 55 may each include a curved surface for correcting the eyesight of the wearer US or a curved surface for a good appearance such as that of sunglasses or non-prescribed glasses to the extent that no inconvenience occurs in terms of optical performance. The flat surfaces 54g, 55g of the compensation lens 54 and the compensation flat plate 55 may each be provided with an antireflection film or a hard coat. The external light OL passing through the compensation flat plate 55 passes through a portion around the compensation lens 54. The external light OL is incident on a peripheral area outside the area on which the image light ML is incident and which corresponds to the compensation lens 54, that is, incident on the compensation flat plate 55. Thus, a wide see-through visual field with respect to the outside can be ensured. The visual field range of the external light OL is set to, for example, about 40° in the upward direction and about 40° in the downward direction.

The transmissive mirror 56 is a half mirror. The transmissive mirror 56 partially reflects the image light ML having passed through the second lens 53 and partially transmits the external light OL. The transmissive mirror 56 reflects, toward the pupil position PP, the image light ML which has been reflected by the reflective polarizing element 45 of the first flat-plate member 40 and passed through the quarter-wave plate 51 and the second lens 53. The transmissive mirror 56 is a concave mirror that covers the pupil position PP, at which the eye EY or the pupil thereof is disposed, and has a concave shape toward the pupil position PP and a convex shape toward the outside. The pupil position PP or the aperture PPa at the pupil position PP is called an eye point or an eye box, and corresponds to an exit pupil EP of the first display unit 20a.

The transmissive mirror 56 transmits a part of the external light OL, and therefore allows see-through viewing of the outside, and can superimpose a virtual image on an external image. On this occasion, the external light OL passes through the first flat-plate member 40 and the second flat-plate member 50, but the flat-plate members 40, 50 do not cause a lens function in the external light OL. The reflectance of the transmissive mirror 56 for the image light ML and the external light OL is set to a value no less than 10 % and no more than 50 % over an assumed incident angle of the image light ML from the viewpoint of ensuring the luminance of the image light ML and facilitating the observation of the external image due to the see-through viewing. The transmissive mirror 56 is formed of, for example, a dielectric multilayer film configured with a plurality of dielectric layers each having an adjusted film thickness. The transmissive mirror 56 may be a monolayer or multilayer film made of metal such as Al or Ag and having an adjusted film thickness. The transmissive mirror 56 is formed by, for example, evaporation-based lamination.

In the first virtual image display apparatus 100A, the first lens 30, the lens portion 44, the second lens 53, and the transmissive mirror 56 each have positive refractive power and tend to cause diverging light to converge. The first lens 30, the lens portion 44, the second lens 53, and the transmissive mirror 56, including a main body of the first prism 41, the second prism 42, and so on, function as the imaging optical system IS or the direct virtual image optical system DIS such as a monocular microscope that forms an erected image. Thus, it is possible to form a virtual image obtained by projecting a real image formed on the display surface 11d of the first image forming element 11a at infinity, or a virtual image obtained by projecting the real image formed on the display surface 11d at a point several meters ahead. On this occasion, the refractive power of each of the first lens 30, the lens portion 44, the second lens 53, and the transmissive mirror 56 is adjusted to shorten the focal length of the imaging optical system IS, so that a desired magnification factor can be achieved.

The size in a longitudinal direction of the first flat-plate member 40 or the second flat-plate member 50 is, for example, 34 mm, and the size thereof in a transverse direction is, for example, 40 mm. The thickness of the first flat-plate member 40 in a front-back direction is in a range of, for example, from about 7 mm to 8 mm, and the total thickness of the first flat-plate member 40 and the second flat-plate member 50 is suppressed to a value in a range from about 7.5 mm to 8.5 mm.

In the first prism 41 of the first flat-plate member 40, there is a possibility that the optical plane of incidence 41a, the first inner side surface 41b, and the first outer side surface 41c cause stray light due to the image light ML. That is, since the first virtual image display apparatus 100A or the optical unit 100 is the direct virtual image optical system DIS, it is not possible to provide an aperture stop, and there is a relatively high possibility that the image light ML travels around to an unintended optical path to reach the pupil position PP, and is observed as a ghost. In the underlying technique before the improvement according to the present disclosure, a light absorption layer AL is disposed at appropriate positions of the first flat-plate member 40 or the prism-based light guide member 48 to thereby achieve suppression of the ghost described above (see FIG. 3).

Specifically, in the first prism 41, the light absorption layer AL is disposed at the upper flat surface 40u. The upper flat surface 40u corresponds to a peripheral area of the optical plane of incidence 41a which is a plane of incidence 40i of the first prism 41. Note that the light absorption layer AL has a contour corresponding to the upper flat surface 40u, but is not limited thereto, and for example, may cover the vicinity of the optical plane of incidence 41a and expose the upper flat surface 40u in an area close to the lateral side surfaces 41e, 42e. Further, the light absorption layer AL to be disposed at the upper flat surface 40u is not essential.

Further, the light absorption layer AL is also disposed in an upper portion UP of the first prism 41, more specifically, an upper end area 41u of the first outer side surface 41c of the first prism 41. The light absorption layer AL disposed in the upper end area 41u is formed as a band-shaped area elongated in the lateral X direction at an upper end of the first outer side surface 41c.

Further, the light absorption layer AL is also disposed at the bottom surface 42f of the prism-based light guide member 48 or the second prism 42. The light absorption layer AL can also prevent the image light ML having passed through the reflective polarizing element 45 from causing the stray light. The second prism 42 has curved surfaces 42g at boundaries between the bottom surface 42f and the second lateral side surfaces 42e. The light absorption layer AL preferably extends from the bottom surface 42f to the curved surfaces 42g. In other words, the light absorption layer AL extends to rounded portions on the boundaries between the bottom surface 42f and the second lateral side surfaces 42e of the second prism 42.

Further, although not essential, the light absorption layer AL may be disposed at surfaces of outer circumferential portions 51f at the left and right sides of the quarter-wave plate 51 or the flat surfaces 55f at the back side of the compensation flat plate 55 corresponding to the outer circumferential portions 51f. The light absorption layer AL targets the image light ML emitted from the prism-based light guide member 48 through, for example, the reflective polarizing element 45 and so on and incident on the vicinity of the outside of the second lens 53, and prevents such unnecessary light from causing a ghost.

As described above, even when the light absorption layer AL is disposed at appropriate positions of the prism-based light guide member 48, there is a concern that the image light ML that goes around to an unintended optical path remains, a large amount of unnecessary light remains outside the image area, and a ghost occurs. In the present embodiment, in order to suppress the ghost described above, the reflective polarizing element 45 including a light deflector LD is disposed between the first prism 41 and the second prism 42.

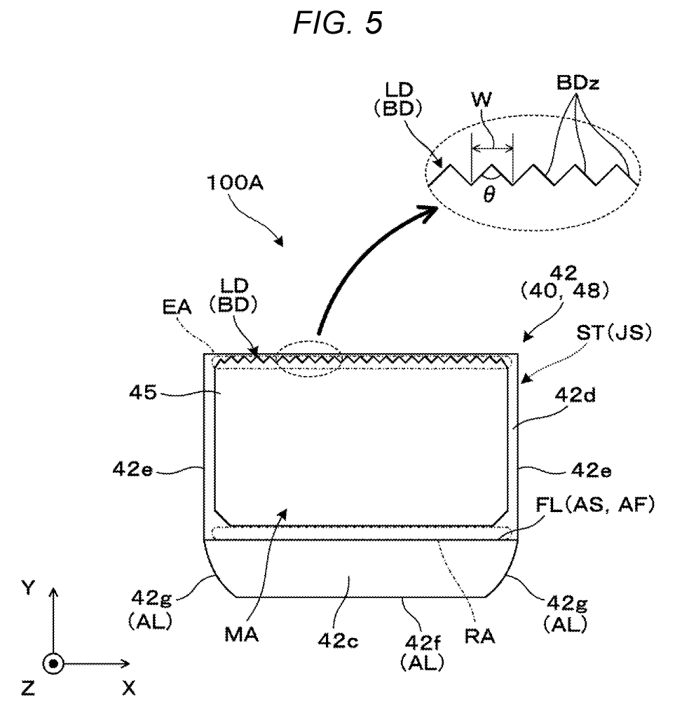

FIGS. 5 and 6 are diagrams illustrating the structure and so on of the reflective polarizing element 45. FIG. 5 is a view of the second prism 42 and the reflective polarizing element 45 viewed from the external side. FIG. 6 is a side cross-sectional view of the prism-based light guide member 48. A structure of the reflective polarizing element 45 and a peripheral portion of the reflective polarizing element 45 will be described with reference to FIG. 5 and so on.

As illustrated in FIGS. 5, 6, and so on, the reflective polarizing element 45 includes the light deflector LD in an end area EA close to the second inner side surface 42b at an opposite side to the second outer side surface 42c. The edge area EA is an area including a side surface or an edge portion at the pupil position PP side in the reflective polarizing element 45. That is, the end area EA is an end portion of the reflective polarizing element 45, closer to the inner side surfaces 41b, 42b of the first prism 41 and the second prism 42, and is an area extending along the inner side surfaces 41b, 42b. The light deflector LD diverts the image light ML incident thereon from a normal optical path of reflection or transmission. That is, the reflective polarizing element 45 suppresses the ghost not only when reflecting the image light ML but also when refracting the image light ML. Note that an area other than the end area EA of the reflective polarizing element 45 is referred to as a main area MA. The main area MA is an area having a substantial polarization separation function without the light deflector LD.

As illustrated in FIG. 5, the reflective polarizing element 45 has a saw-blade shape BD in the end area EA as the light deflector LD. The saw-blade shape BD has a function of preventing an image light ghost. Accordingly, the unintended image light ML can be deviated from the optical path leading to the pupil position PP. Specifically, the unnecessary light is deviated to the left and right with the saw-blade shape BD to reduce the light high in luminance. To deviate the unnecessary light to the left and right means to bend the unnecessary light in a direction so as not to affect the image quality instead of reflecting the unnecessary light to the original path.

In the saw-blade shape BD, for example, a plurality of isosceles triangular saw teeth BDz having a tip end angle θ of 90° is arranged. In FIG. 5, the saw-blade shape BD is illustrated in an exaggerated manner for the sake of convenience of description, but in reality, the saw-blade shape BD is a fine structure. The width W of one saw tooth BDz is, for example, about 1 μm.

The light deflector LD is not limited to the saw-blade shape BD and may have another shape, specifically, an uneven shape or a shape having fine holes as long as the image light ML is deviated to the left and right. Further, the saw-blade shape BD may be a shape in which the saw tooth BDz is blunt or a shape in which the saw tooth BDz having an acute tip is slightly laid down.

As illustrated in FIG. 6 and so on, the reflective polarizing element 45 has adhesive members AD on a surface facing the first prism 41 and a surface facing the second prism 42. Accordingly, since the first prism 41 and the second prism 42 are bonded to each other with the adhesive members AD provided to the reflective polarizing element 45, no adhesive is separately required.

FIG. 7 is an enlarged cross-sectional view illustrating the reflective polarizing element 45 before being attached to the first prism 41 and the second prism 42. As illustrated in FIG. 7, the adhesive members AD are disposed at both surfaces 45j, 45k of a reflective polarizing plate 45a which is a main body of the reflective polarizing element 45. The reflective polarizing element 45 is a reflective polarizing plate with adhesive films which is configured with a combination of the reflective polarizing plate 45a shaped like a flat plate or a film and the adhesive members AD. The entire thickness d1 of the reflective polarizing element 45 is in a range of, for example, 70 μm to 110 μm, and is specifically 101 μm. The thickness d2 of the reflective polarizing plate 45a of the reflective polarizing element 45 is in a range of, for example, 50 μm to 90 μm, and is specifically 83 μm. The thickness d3 of the adhesive member AD is in a range of, for example, 2 μm to 10 μm, and is specifically 9 μm.

The adhesive member AD is, for example, an optical clear adhesive (OCA). The OCA is an adhesive sheet shaped like a film. The OCA has a refractive index close to that of the first prism 41 or the second prism 42 to be bonded. The thickness of the OCA is uniform or substantially uniform and is small in product variation. Further, unlike an adhesive, the OCA does not cause overflow of surplus adhesive.

Before the reflective polarizing element 45 is attached, both surfaces 45m, 45n of the reflective polarizing element 45 are protected by protective films PF. The reflective polarizing element 45 which is not molded and is protected by the protective films PF is referred to as a blank member 45x. The reflective polarizing element 45 forms the saw-blade shape BD by punching the blank member 45x using a Thomson die (not shown).

As illustrated in FIG. 5 and so on, the size of the reflective polarizing element 45 is smaller than the sizes of the inclined surfaces 41d, 42d in the inclination direction of the inclined surfaces 41d, 42d of the first prism 41 and the second prism 42. That is, the reflective polarizing element 45 is not disposed at the lower ends of the inclined surfaces 41d, 42d. Accordingly, as shown in FIG. 6, when the reflective polarizing element 45 is sandwiched between the first and second prisms 41, 42, a gap PN is formed at the external side and so on. Due to the gap PN, an inclined surface exposure area RA is present at the junction portion JS of the prism-based light guide member 48. The inclined surface exposure area RA limits the reflection area of the image light ML in the reflective polarizing element 45 in the inclined surface portion ST, and allows the unintended image light ML to pass through an allowable area around the reflective polarizing element 45. That is, it is possible to prevent the unnecessary light causing the ghost from being incident on the reflective polarizing element 45 and to reduce the reflection of the unnecessary light by the reflective polarizing element 45.

The reflective polarizing element 45 is disposed, for example, about 3 mm away from the lower end of the first inclined surface 41d of the first prism 41 or the second inclined surface 42d of the second prism 42. Note that the reflective polarizing element 45 may be disposed slightly away from the upper end of the first inclined surface 41d of the first prism 41 or the second inclined surface 42d of the second prism 42. In this case, the distance from the upper ends of the inclined surfaces 41d, 42d is 1 mm or less. Further, the reflective polarizing element 45 may be disposed from the lower ends of the inclined surfaces 41d, 42d by adjusting the length of the planar portions FL. The reflective polarizing element 45 is disposed, for example, about 1 mm away from the lateral side surfaces 41e, 42e of the first prism 41 or the second prism 42. Note that the reflective polarizing element 45 is not required to be disposed away from the lateral side surfaces 41e, 42e of the first prism 41 or the second prism 42.

The reflective polarizing element 45 selectively reflects the image light ML in accordance with the polarization direction of the image light ML in the main area MA other than the end area EA. Further, as described above, even when an unintended component of the image light ML is incident on the first prism 41, the light deflector LD provided to the end area EA deviates the image light ML from the optical path that causes the ghost. Accordingly, it is possible to efficiently reflect the image light ML in the normal optical path while limiting the reflection or transmission of the unnecessary light causing the ghost in the end area EA. As a result, it is possible to prevent a ghost from being observed around the virtual image as the observation target.

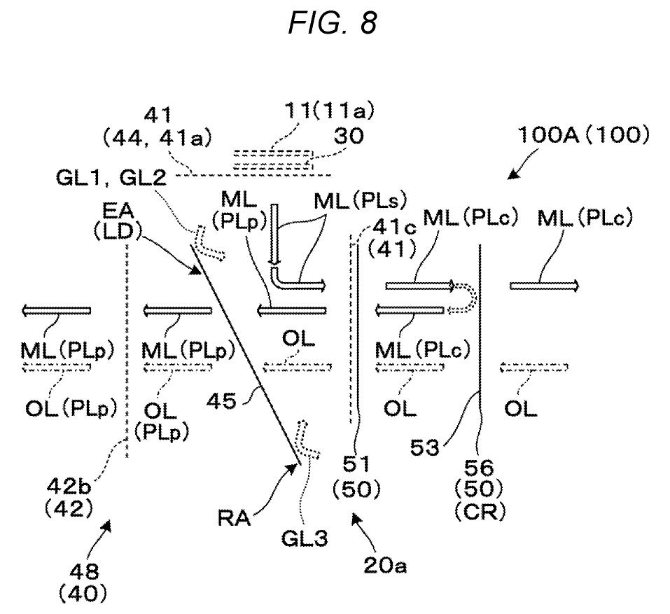

FIG. 8 illustrates the optical path and so on of the first virtual image display apparatus 100A. As shown in FIG. 8, the image light ML from the first image forming element 11a enters the first prism 41 via the first lens 30. On this occasion, the degree of divergence of the image light ML is suppressed by the positive refractive power of the first lens 30 and the lens portion 44. In the optical path passing through the first prism 41, the image light ML is sequentially reflected by the first inner side surface 41b of the first prism 41 and the first outer side surface 41c of the first prism 41 without forming an intermediate image (see FIG. 2), and the s-polarized light PLs in the image light ML is reflected by the reflective polarizing element 45. The image light ML as the s-polarized light PLs reflected by the reflective polarizing element 45 is transmitted through the first outer side surface 41c of the first prism 41, and then passes through the quarter-wave plate 51 of the second flat-plate member 50 to thereby be converted into the circularly polarized light PLc, and enters the second lens 53 and the transmissive mirror 56. A part of the image light ML as the circularly polarized light PLc incident on the transmissive mirror 56 is reflected by the transmissive mirror 56, and then passes through the quarter-wave plate 51 once again in a state of being collimated through the second lens 53. Thus, the image light ML having passed through the quarter-wave plate 51 turns to the p-polarized light PLp, enters the first prism 41 via the first outer side surface 41c, then is transmitted through the reflective polarizing element 45, and is then emitted to the outside of the second prism 42 via the second inner side surface 42b. The image light ML having been emitted to the outside of the second prism 42 is incident on the pupil position PP where the eye EY or the pupil of the wearer US is disposed (see FIG. 2). Not only the image light ML having been reflected by the transmissive mirror 56 but also the external light OL having passed through the transmissive mirror 56, and the external light OL having passed through the compensation flat plate 55 are incident on the pupil position PP. That is, the wearer US who wears the first virtual image display apparatus 100A can observe a virtual image with the image light ML superimposed on the external image. In the present embodiment, the observation of the ghost is suppressed by limiting such unnecessary light GL1 to GL3 as described below with the light deflector LD and the inclined surface exposed area RA of the reflective polarizing element 45.

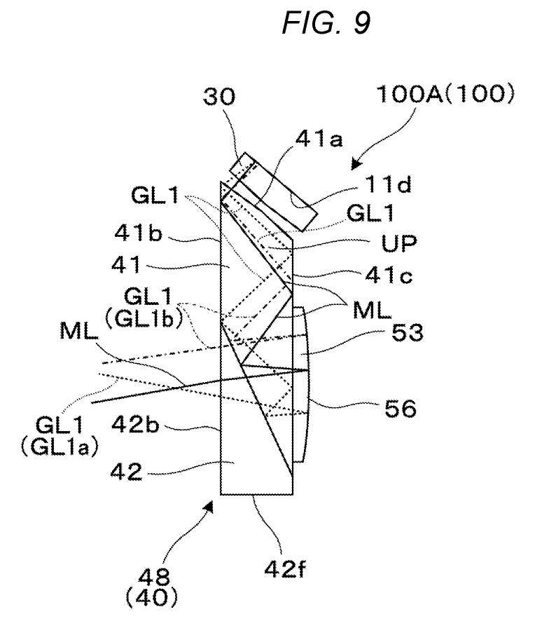

FIG. 9 is a conceptual diagram specifically illustrating the unnecessary light GL1 caused by the image light ML incident on the upper portion UP of the first prism 41 from an unintended optical path. In this case, unnecessary light GL1a, which is a specific component of the unnecessary light GL1, is sequentially reflected by the first inner side surface 41b and the first outer side surface 41c at an unexpected location in the upper portion UP of the first prism 41. As a result, the unnecessary light GL1a is reflected twice by each of the first inner side surface 41b and the first outer side surface 41c in the first prism 41, passes through the reflective polarizing element 45 and the transmissive mirror 56, and is incident on the pupil position PP (see FIG. 2) at an angle of about 17° from the obliquely downward direction together with the image light ML from the normal optical path. The unnecessary light GL1a forms a ghost image outside the image area of the virtual image and below the image area. Unnecessary light GL1b, which is another component of the unnecessary light GL, is sequentially reflected by the first inner side surface 41b and the first outer side surface 41c at an unexpected location in the upper portion UP of the first prism 41. The unnecessary light GL1b is incident on the pupil position PP at an angle of about 17° from the obliquely upward direction together with the image light ML from the normal optical path via the reflective polarizing element 45 and the transmissive mirror 56. The unnecessary light GL1b forms a ghost image outside the image area of the virtual image and below the image area. However, the passage of such unnecessary light GL1, that is, the unnecessary light GL1a, GL1b is restricted by the light deflector LD of the reflective polarizing element 45 illustrated in FIG. 5 and so on, and the observation of the ghost is suppressed.

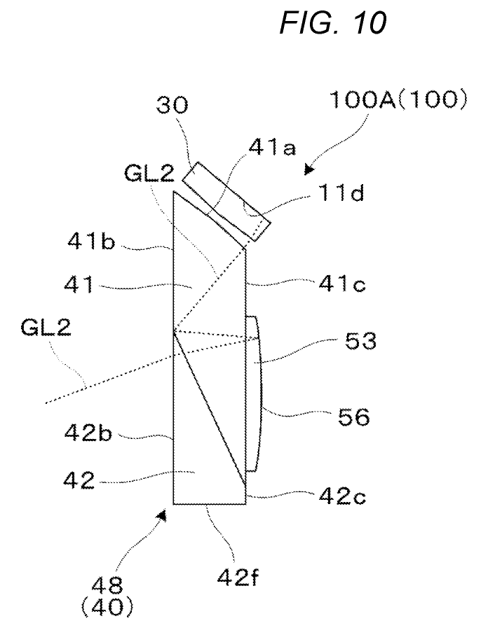

FIG. 10 illustrates an optical path of unnecessary light GL2 caused by other image light ML incident on the optical plane of incidence 41a of the first prism 41 from an unintended optical path. In this case, the unnecessary light GL2 is reflected by an upper end of the reflective polarizing element 45 on the boundary between the first prism 41 and the second prism 42 to deviate from the optical path, passes through the transmissive mirror 56 and so on, and is incident on the pupil position PP (see FIG. 2) at an angle of about 20° from the obliquely upward direction. The unnecessary light GL2 forms a ghost image outside the image area of the virtual image and above the image area. However, the passage of such unnecessary light GL2 is restricted by the light deflector LD disposed in the end area EA of the reflective polarizing element 45, and the observation of the ghost is suppressed.

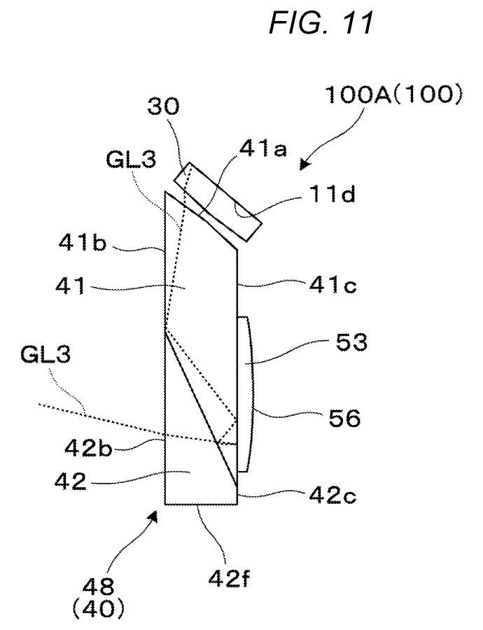

FIG. 11 illustrates an optical path of unnecessary light GL3 caused by still other image light ML incident on the optical plane of incidence 41a of the first prism 41 from an unintended optical path. In this case, the unnecessary light GL3 is sequentially reflected by the first inner side surface 41b and the first outer side surface 41c, is reflected by the first outer side surface 41c without being incident on the transmissive mirror 56 via the reflective polarizing element 45, and is incident on the pupil position PP (see FIG. 2) at an angle of about 13° from an obliquely downward direction. The unnecessary light GL3 forms a ghost image outside the image area of the virtual image and below the image area. However, the passage of such unnecessary light GL3 is limited mainly by the presence of the inclined surface exposure area RA, that is, by limiting the size at the external side of the reflective polarizing element 45 at the external side or with the second lens 53, and the observation of the ghost is suppressed.

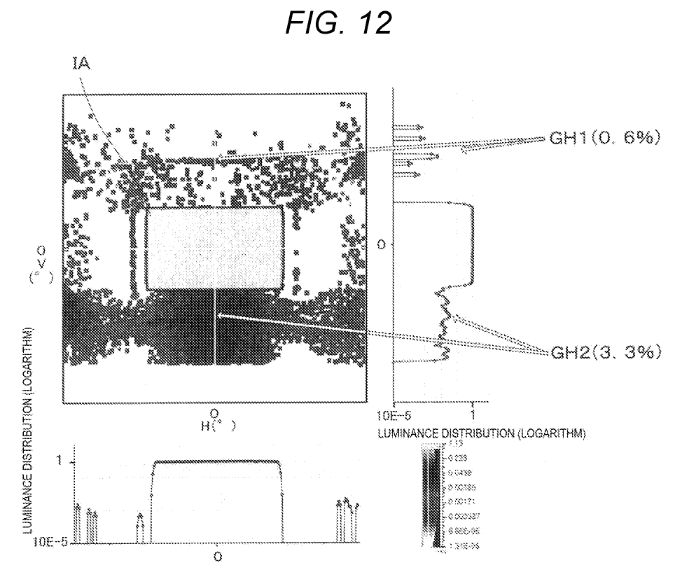

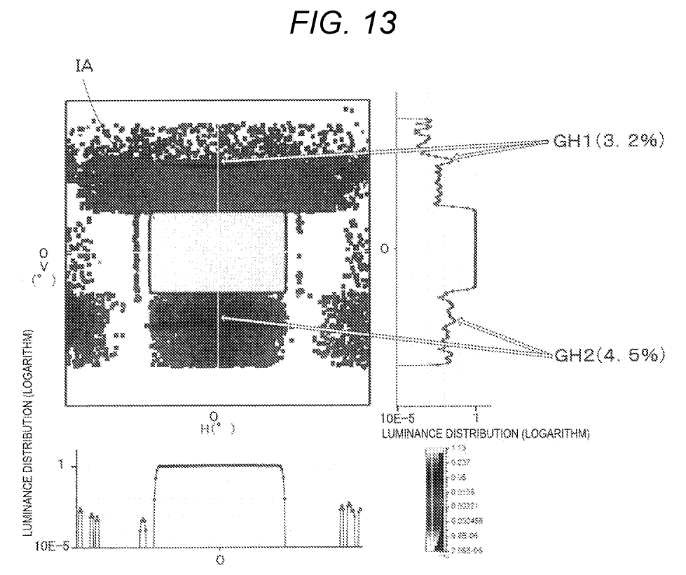

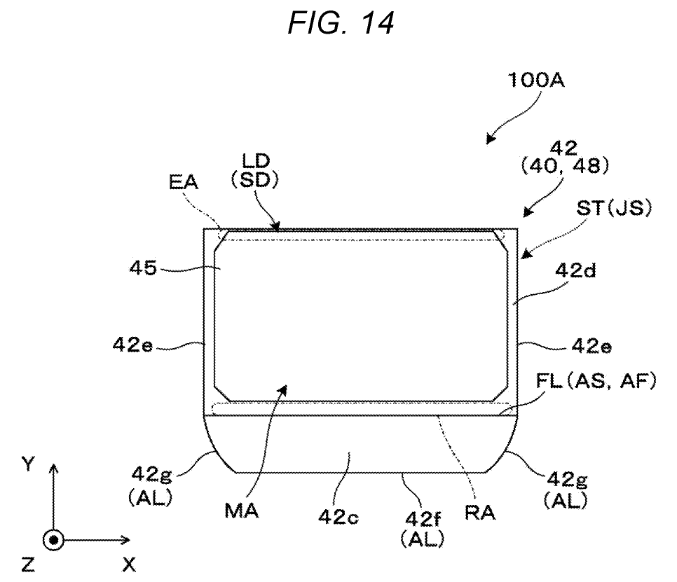

FIG. 12 is a diagram illustrating a projection state of unnecessary light in the virtual image display apparatus 100A of a practical example according to the present embodiment. FIG. 13 is a diagram illustrating a projection state of unnecessary light in a virtual image display apparatus of a comparative example. FIG. 12 illustrates when the first virtual image display apparatus 100A includes the reflective polarizing element 45 illustrated in FIG. 5 and so on. FIG. 13 illustrates when the inclined surface exposure area RA is provided, but the reflective polarizing element 45 is not provided with the light deflector LD in the first virtual image display apparatus 100A. Specifically, the reflective polarizing element 45 in the comparative example is obtained by linearly cutting the end area EA of a blank member 45x illustrated in FIG. 7 with a cutter blade or the like.

In FIGS. 12 and 13, a simulation image showing a detection state by an angle light receiver arranged at the pupil position PP when an all-white image is displayed on the display element 11 is shown in an upper left area. A graph showing a logarithmic display of a luminance distribution on a vertical axis line at the center at an angle of 0° on an H axis (horizontal axis) is shown at the right side of the simulation image, and a graph showing a logarithmic display of a luminance distribution on a horizontal axis line at the center at an angle of 0° on a V axis (vertical axis) is shown at the lower side of the simulation image. As a premise of the simulation, the angle light receiver evaluates the observation image in the entire eye box set at the pupil position PP. Each numerical value shown in the luminance distribution in the H axis and the V axis represents a rate of the unnecessary light when the luminance of the image area IA viewed at the center of the screen of the simulation image is set to 100%. In FIGS. 12 and 13, ghosts GH1 of a first type and ghosts GH2 of a second type in the ghosts generated above and below the image area IA are compared. The ghosts GH1 of the first type are formed at the upper side of the image area IA. The ghosts GH2 of the second type are formed at the lower side of the image area IA.

As illustrated in FIG. 12, in the virtual image display apparatus of the practical example, the luminance of the ghosts GH1 of the first type is about 0.6 % compared to the luminance in the central image area IA. The luminance of the ghosts GH2 of the second type is about 3.3 % compared to the luminance in the central image area IA.

As shown in FIG. 13, in the virtual image display apparatus of the comparative example, the luminance of the ghosts GH1 of the first type is about 3.2 % compared to the luminance in the central image area IA. The luminance of the ghosts GH2 of the second type is about 4.5 % compared to the luminance in the central image area IA.

From the above, it is understood that, in the virtual image display apparatus of the practical example, the ghost is further reduced by disposing the light deflector LD in the end area EA of the reflective polarizing element 45. On the other hand, in the virtual image display apparatus of the comparative example, since the end area EA of the reflective polarizing element 45 has a linear shape, unnecessary light is generated due to the fact that light totally reflected by the end area EA propagates to the lower side of the prism-based light guide member 48 at an angle changed from the original angle.

An example of the structure and assembly of the first display unit 20a constituting the first virtual image display apparatus 100A will be described. The first prism 41 and the second prism 42 are prepared. The reflective polarizing element 45 is bonded between the first prism 41 and the second prism 42 via the adhesive members AD. As a result, the first prism 41 and the second prism 42 are joined at the inclined surfaces 41d, 42d to obtain the prism-based light guide member 48 or the first flat-plate member 40. In parallel with this, a unit obtained by integrally joining the quarter-wave plate 51, the second lens 53 provided with the transmissive mirror 56, and the optical element 58 is prepared, and this unit is attached to the outer side surfaces 41c, 42c of the first flat-plate member 40 so as to be opposed thereto. On this occasion, the spacer 61 as a pair of thin adhesives is disposed between the outer side surfaces 41c, 42c of the first flat-plate member 40 and the quarter-wave plate 51, and thus, the gap SP is formed between the outer side surfaces 41c, 42c of the first flat-plate member 40 and the quarter-wave plate 51.

The light absorption layer AL can appropriately be provided in the assembly process or after the assembly of the first display unit 20a.

The virtual image display apparatus 100A, 100B or the optical unit 100 according to the first embodiment described hereinabove includes the display element 11 configured to output the image light ML, the first prism 41 on which the image light ML from the display element 11 is incident, the second prism 42 bonded to the first prism 41 to constitute the prism-based light guide member 48 having a parallel flat plate shape, the reflective polarizing element 45 which is disposed at the junction portion JS between the first prism 41 and the second prism 42 via the adhesive members AD, and is configured to reflect at least a part of the image light ML guided in the first prism 41, the lens having positive power and disposed so as to face the outer side surface of the first prism 41 on which the image light ML reflected by the reflective polarizing element 45 is incident, the transmissive mirror 56 formed at the external side of the lens, and configured to partially reflect, toward the reflective polarizing element 45, the image light ML reflected by the reflective polarizing element 45, and the quarter-wave plate 51 disposed between the outer side surface of the first prism 41 and the lens, in which the reflective polarizing element 45 has the light deflector LD in the end area EA close to the inner side surface at an opposite side to the outer side surface.

In the virtual image display apparatus 100A, 100B or the optical unit 100 described above, since the reflective polarizing element 45 has the light deflector LD in the end area EA close to the inner side surface, even when an unintended component of the image light ML is incident on the upper portion of the first prism 41, the light can be deviated by the light deflector LD, and thus it is possible to reduce unnecessary light that causes a ghost that degrades the image quality. Accordingly, it is possible to prevent a ghost from being observed around the virtual image which is the observation target.

### Second Embodiment

A virtual image display apparatus and so on according to a second embodiment will hereinafter be described. Note that the virtual image display apparatus according to the second embodiment is obtained by partially changing the virtual image display apparatus according to the first embodiment, and the description of portions common to those of the virtual image display apparatus according to the first embodiment will be omitted.

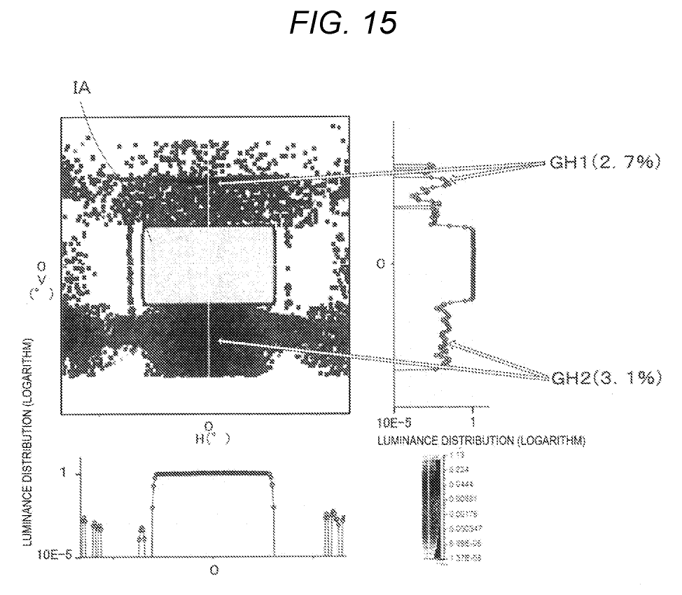

FIG. 14 is a diagram illustrating a reflective polarizing element 45 of the virtual image display apparatus 100A according to the second embodiment. As illustrated in FIG. 14, the reflective polarizing element 45 has a scattering shape SD in the end area EA as the light deflector LD. Accordingly, the unintended image light ML can be deviated from the optical path leading to the pupil position PP. Thus, the light high in luminance is reduced.

The scattering shape SD is obtained by performing diffusion treatment on an end surface cut linearly. The diffusion treatment is a treatment of providing an uneven shape to the end area EA using a liquid or a jet device such as a spray. The diffusion treatment is performed in a state where the protective film PF illustrated in FIG. 7 is attached.

FIG. 15 is a diagram illustrating a projection state of the unnecessary light in the virtual image display apparatus 100A according to the second embodiment.

As illustrated in FIG. 15, in the virtual image display apparatus according to the second embodiment, the luminance of the ghosts GH1 of the first type is about 2.7 % compared to the luminance in the central image area IA. The luminance of the ghosts GH2 of the second type is about 3.1 % compared to the luminance in the central image area IA.

### Third Embodiment

A virtual image display apparatus and so on according to a third embodiment will hereinafter be described. Note that the virtual image display apparatus according to the third embodiment is obtained by partially changing the virtual image display apparatus according to the first embodiment, and the description of portions common to those of the virtual image display apparatus according to the first embodiment will be omitted.

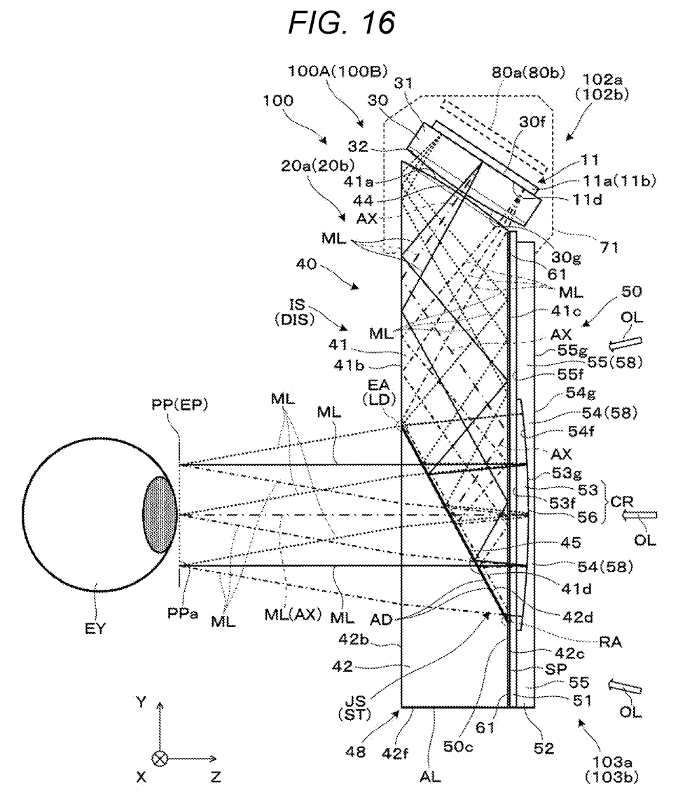

FIG. 16 is a side cross-sectional view illustrating a virtual image display apparatus 100A according to the third embodiment. As illustrated in FIG. 16, the virtual image display apparatus 100A according to the third embodiment does not include the planar portions FL illustrated in FIG. 2 and so on at the first inclined surface 41d of the first prism 41 and the second inclined surface 42d of the second prism 42.

### Modified Examples and Others

The present disclosure has been described above with reference to the embodiments, but is not limited to the embodiments described above, and can be implemented in various forms without departing from the gist of the present disclosure. For example, the following modifications are conceivable.

In the above description, the HMD 200 includes the first virtual image display apparatus 100A and the second virtual image display apparatus 100B, but the HMD 200 may support the single first virtual image display apparatus 100A or second virtual image display apparatus 100B in front of the eyes with the aid of the support devices 100C.

The display element 11 may be an element that emits the image light ML as linearly polarized light, or a polarization filter may be provided in a posterior stage of the display element 11. Accordingly, the image light ML as the s-polarized light PLs can be incident on the reflective polarizing element 45.

The positioning structure AS is not limited to one formed only of the planar portion FL, and may have, for example, a shape including a step that enables positioning. The planar portions FL can be disposed at distances from the inclined surfaces 41d, 42d. In this case, a connection surface formed of a flat surface or a curved surface, or a step formed of a plurality of surfaces can be disposed between the planar portion FL and each of the inclined surfaces 41d, 42d. The planar portion FL may be disposed so as to be divided into two or more portions in the lateral X direction, for example.

In the cover member 52, the compensation flat plate 55 can be omitted. In this case, the quarter-wave plate 51 is disposed only over the range of the second lens 53, and the second lens 53 is covered with the compensation lens 54.

In the second flat-plate member 50, the cover member 52 may be omitted.

One surface of the reflective polarizing element 45 may be bonded with the adhesive member AD such as an OCA, and the other surface may be bonded with an adhesive as long as the adhesive does not spread.

The first lens 30 is not essential and can be omitted. In the first prism 41 of the first flat-plate member 40, the optical plane of incidence 41a may be omitted. In this case, the lens portion 44 is omitted from the optical system.

The first lens 30 is not necessarily bonded to the first image forming element 11a, and may be disposed separately from the first image forming element 11a.

The second lens 53 is not limited to a planoconvex lens having positive power, and can be replaced with a diffraction lens, a hologram lens, a liquid crystal lens, or the like having positive power. In this case, the compensation lens 54 can be, for example, a diffraction lens, a hologram lens, or the like having an inverted shape. On this occasion, an optical element itself such as a diffraction lens, a hologram lens, or a liquid crystal lens as the second lens 53 can be provided with a function of partially reflecting the image light ML, but a planar transmissive mirror may be disposed at the external side of such an optical element.

The light absorption layer AL may be omitted.

The gap PN at the lower side formed between the first prism 41 and the second prism 42 may be filled with an adhesive, but is not required to be filled with an adhesive.

The saw-blade shape BD of the light deflector LD is not limited to when being formed by a cutter blade such as a Thomson die, and may be formed by, for example, laser processing.

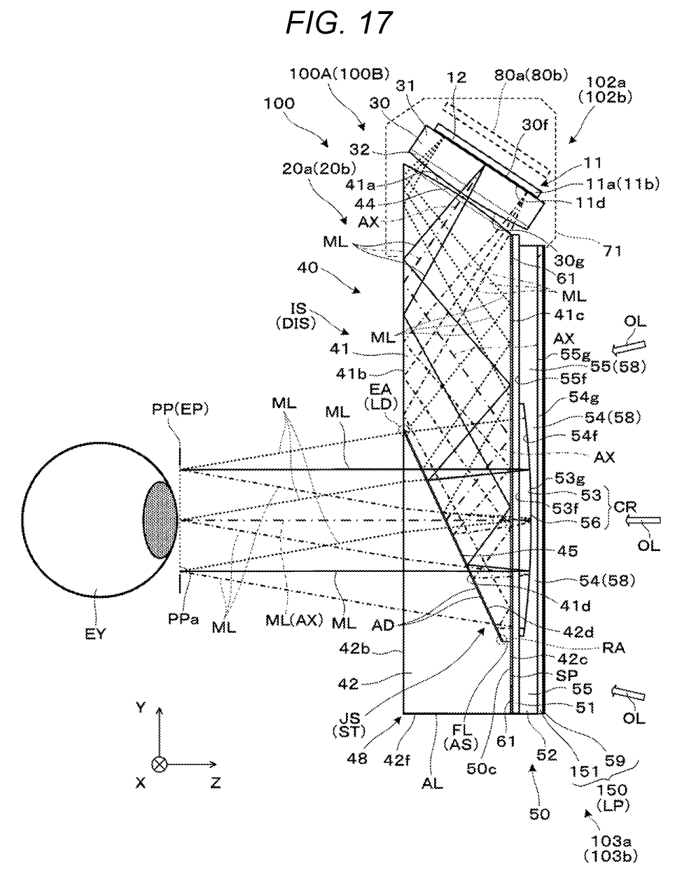

As illustrated in FIG. 17, in the first virtual image display apparatus 100A, for example, the s-polarized light transmissive polarizing plate 12 may be disposed between the first lens 30 and the display element 11 in the first display unit 20a. Furthermore, in the first display unit 20a, a third flat-plate member 150 is added at the external side of the second flat-plate member 50. The third flat-plate member 150 is an image light blocking portion LP. The third flat-plate member 150 includes an outer quarter-wave plate 151 disposed at the external side of the transmissive mirror 56 or the light collecting reflector CR, and a polarizing plate 59 disposed at the external side of the outer quarter-wave plate 151. That is, the first display unit 20a has a structure in which the inner quarter-wave plate 51 and the outer quarter-wave plate 151 are disposed between the inner reflective polarizing element 45 and the outer polarizing plate 59. The polarizing plate 59 selectively absorbs the image light ML having passed through the outer quarter-wave plate 151 in accordance with the polarization direction of the image light ML.

The circularly polarized image light ML transmitted through the transmissive mirror 56 becomes p-polarized light by passing through the outer quarter-wave plate 151, enters the polarizing plate 59, and is mostly blocked by the polarizing plate 59. That is, the image light ML is blocked by the third flat-plate member 150 and does not leak to the outside. Thus, since the image light ML is prevented from being observed from the outside, the privacy can be ensured. In contrast, the external light OL having entered the polarizing plate 59 becomes only the s-polarized light after passing through the polarizing plate 59, and becomes the circularly polarized light after passing through the outer quarter-wave plate 151, and is partially transmitted through the transmissive mirror 56. The external light OL as the circularly polarized light having been partially transmitted through the transmissive mirror 56 becomes the p-polarized light after passing through the inner quarter-wave plate 51, and is then transmitted through the reflective polarizing element 45, and is incident on the pupil position PP.

A virtual image display apparatus in a specific aspect includes a display element configured to emit image light, a first prism on which the image light from the display element is incident, a second prism bonded to the first prism to constitute a prism-based light guide member having a parallel flat plate shape, a reflective polarizing element which is disposed at a junction portion between the first prism and the second prism via an adhesive member, and is configured to reflect at least a part of the image light guided in the first prism, a lens having positive power and disposed so as to face an outer side surface of the first prism on which the image light reflected by the reflective polarizing element is incident, a transmissive mirror formed at an external side of the lens, and configured to partially reflect, toward the reflective polarizing element, the image light reflected by the reflective polarizing element, and a quarter-wave plate disposed between the outer side surface of the first prism and the lens, wherein the reflective polarizing element has a light deflector in an end area close to an inner side surface at an opposite side to the outer side surface.

In the virtual image display apparatus described above, since the reflective polarizing element has the light deflector in the end area close to the inner side surface, even when an unintended component of the image light is incident on the upper portion of the first prism, the light can be deviated by the light deflector, and thus it is possible to reduce unnecessary light that causes a ghost that degrades the image quality. Accordingly, it is possible to prevent a ghost from being observed around the virtual image which is the observation target.

In the virtual image display apparatus in the specific aspect, the reflective polarizing element has adhesive members on a surface facing the first prism and a surface facing the second prism. In this case, since the first prism and the second prism are bonded to each other with the adhesive members provided to the reflective polarizing element, no adhesive is separately required.

In the virtual image display apparatus in the specific aspect, the reflective polarizing element selectively reflects the image light in accordance with a polarization direction of the image light in a main area other than the end area. In this case, it is possible to efficiently reflect the image light in the normal optical path while limiting the reflection or transmission of the unnecessary light causing the ghost in the end area.

In the virtual image display apparatus in the specific aspect, the reflective polarizing element has a saw-blade shape in the end area as the light deflector. In this case, unintended image light can be deviated from the optical path leading to the pupil position.

In the virtual image display apparatus in the specific aspect, the reflective polarizing element has a scattering shape in the end area as the light deflector. In this case, unintended image light can be deviated from the optical path leading to the pupil position.

In the virtual image display apparatus in the specific aspect, a size of the reflective polarizing element is smaller than sizes of inclined surfaces of the first prism and the second prism in an inclination direction of the inclined surfaces. In this case, it is possible to prevent unnecessary light that causes a ghost from being incident on the reflective polarizing element and to reduce reflection of the unnecessary light by the reflective polarizing element.

In the virtual image display apparatus in the specific aspect, the reflective polarizing element is disposed at a distance from the outer side surface.

In the virtual image display apparatus according to the specific aspect, the junction portion between the first prism and the second prism has a planar portion at the outer side surface side. In this case, by using the planar portion as a contact surface, it is possible to make it easy to assemble the first prism and the second prism.

An optical unit in a specific aspect includes a first prism on which the image light from the display element is incident, a second prism bonded to the first prism to constitute a prism-based light guide member having a parallel flat plate shape, a reflective polarizing element which is disposed at a junction portion between the first prism and the second prism via an adhesive member, and is configured to reflect at least a part of the image light guided in the first prism, a lens having positive power and disposed so as to face a first outer side surface of the first prism on which the image light reflected by the reflective polarizing element is incident, a transmissive mirror formed at an external side of the lens, and configured to partially reflect, toward the reflective polarizing element, the image light reflected by the reflective polarizing element, and a quarter-wave plate disposed between the outer side surface of the first prism and the lens, wherein the reflective polarizing element has a light deflector in an end area close to an inner side surface at an opposite side to the outer side surface.

What is claimed is:

1. A virtual image display apparatus, comprising:
a display element configured to emit an image light;
a first prism on which the image light from the display element is incident;
a second prism bonded to the first prism to constitute a prism-based light guide member having a parallel flat plate shape;
a reflective polarizing element which is disposed at a junction portion between the first prism and the second prism via an adhesive member, and is configured to reflect at least a part of the image light guided in the first prism;
a lens having positive power and disposed so as to face an outer side surface of the first prism on which the image light reflected by the reflective polarizing element is incident;
a transmissive mirror formed at an external side of the lens, and configured to partially reflect, toward the reflective polarizing element, the image light reflected by the reflective polarizing element; and
a quarter-wave plate disposed between the outer side surface of the first prism and the lens, wherein
the reflective polarizing element has a light deflector in an end area close to an inner side surface at an opposite side to the outer side surface.

2. The virtual image display apparatus according to claim 1, wherein
the reflective polarizing element has adhesive members on a surface facing the first prism and a surface facing the second prism.

3. The virtual image display apparatus according to claim 1, wherein
the reflective polarizing element selectively reflects the image light in accordance with a polarization direction of the image light in a main area other than the end area.

4. The virtual image display apparatus according to claim 1, wherein
the reflective polarizing element has a saw-blade shape in the end area as the light deflector.

5. The virtual image display apparatus according to claim 1, wherein
the reflective polarizing element has a scattering shape in the end area as the light deflector.

6. The virtual image display apparatus according to claim 1, wherein
a size of the reflective polarizing element is smaller than sizes of inclined surfaces of the first prism and the second prism in an inclination direction of the inclined surfaces.

7. The virtual image display apparatus according to claim 6, wherein
the reflective polarizing element is disposed at a distance from the outer side surface.

8. The virtual image display apparatus according to claim 1, wherein
the junction portion between the first prism and the second prism has a planar portion at the outer side surface side.

9. An optical unit, comprising:
a first prism on which an image light from the display element is incident;
a second prism bonded to the first prism to constitute a prism-based light guide member having a parallel flat plate shape;
a reflective polarizing element which is disposed at a junction portion between the first prism and the second prism via an adhesive member, and is configured to reflect at least a part of the image light guided in the first prism;
a lens having positive power and disposed so as to face a first outer side surface of the first prism on which the image light reflected by the reflective polarizing element is incident;
a transmissive mirror formed at an external side of the lens, and configured to partially reflect, toward the reflective polarizing element, the image light reflected by the reflective polarizing element; and
a quarter-wave plate disposed between the outer side surface of the first prism and the lens, wherein
the reflective polarizing element has a light deflector in an end area close to an inner side surface at an opposite side to the outer side surface.
